(19) United States
(12) Patent Application Publication
(10) Pub. No.: US 2025/0317801 A1
(43) Pub. Date: Oct. 9, 2025

(54) SYSTEMS AND METHODS FOR DYNAMICALLY MANAGING VOLTE CODECS

(71) Applicant: T-Mobile Innovations LLC, Overland Park, KS (US)

(72) Inventors: Harikishore ALLU BALAN, Lynnwood, WA (US); Jagannadha Anudeep Varma DATLA, Kent, WA (US)

(21) Appl. No.: 18/625,384

(22) Filed: Apr. 3, 2024

(51) Int. Cl. H04W 28/18

(52) U.S. Cl. CPC H04W 28/18

(57) ABSTRACT

Systems and methods are provided for managing VOLTE codecs for voice calls in wireless networks. An example method may include monitoring a signal quality metric of an originating wireless device during a voice call with a terminating wireless device. If it is determined that the signal quality metric drops below a threshold, the codec for the portion of the call between the originating wireless device and the media gateway is transitioned to an alternative codec, such as Enhance Voice Services, for example.

### TECHNICAL BACKGROUND

A wireless network, such as a cellular network, can include an access node (e.g., base station) serving multiple wireless devices including both mobile and fixed wireless devices in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to wireless devices.

Even though most aspects of cellular service are implemented using standards, such as those defined by the 3GPP, implementation details can differ between providers. Communication between different cellular network providers often requires translation between the different providers' networks. This translation can often be resource intensive, and some efficiencies may be gained by better controlling the translation process.

### OVERVIEW

Examples described herein include systems and methods for managing VOLTE codecs in wireless networks. An exemplary method includes monitoring a signal quality metric of an originating wireless device during a voice call with a terminating wireless device. The method further includes determining that the signal quality metric has dropped below a threshold. The method further includes transitioning a codec of the voice call to an alternative codec between the originating wireless device and a Media Gateway (MGW).

Another exemplary embodiment includes a system including a Session Border Gateway (SBG) including at least one electronic processor configured to perform operations. The operations include monitoring a signal quality metric of a wireless device during a voice call. The operations further include determining that the signal quality metric has dropped below a threshold. The operations further include transitioning a codec of the voice call to an alternative codec between the wireless device and the MGW.

Another exemplary method includes receiving a request to start a voice call from an originating wireless device. The method further includes negotiating a negotiated codec for use in the voice call with a receiving wireless device. The method further includes using the negotiated codec for the voice call. The method further includes monitoring a signal quality metric during the voice call. The method further includes upon the signal strength dropping below a threshold, transitioning from the negotiated codec to an alternative codec between the originating wireless device and an MGW of a cellular provider of the originating wireless device.

### BRIEF DESCRIPTION OF DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an example processing node in accordance with various aspects of the present disclosure;

FIG. 3 illustrates an example process flow for managing VOLTE codecs; and

FIG. 4 illustrates an example process flow for managing VOLTE codecs.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by many components working together. Some of these components include access nodes, Session Border Gateways (SBGs), and Media Gateways (MGWs). The access nodes work to provide communication between wireless devices and the rest of the cellular provider's network. The SBG of one provider works to interface with the SBG of other providers to provide interoperability between the networks of the separate providers. The MGWs perform transcoding between codecs as described below.

When a phone call is made on a wireless device, the audio is converted to digital packets for transport across the cellular network. A codec, short for coder/decoder, is used to convert the audio. Some common codecs are Enhanced Voice Services (EVS), Adaptive Multi-Rate Wideband (AMR-WB), and Adaptive Mult-Rate Narrowband (AMR-NB). EVS is newer and offers better coverage than AMR-WB or AMR-NB, but at a slightly higher cost in terms of processing resources. EVS provides features not available in AMR-WB or AMR-NB and has a better method of dealing with dropped packets while preserving call quality. Different providers tend to favor one over the other and therefore phone calls between different providers will often need to be transcoded from one codec to another to be properly communicated between providers.

When a phone call is made from a wireless device served by Provider A, which favors EVS, to a wireless device served by Provider B, which favors AMR-WB, some transcoding may be necessary. Provider A may use EVS between the wireless device and the MGW, but then transcode the packets to AMR-WB for transport to Provider B's network where it is transported to the receiving wireless device. The two providers may negotiate a codec for the call, AMR-WB for example, but if Provider A favors EVS, it may still use EVS within its own network and this results in the same situation where Provider A uses EVS between the originating wireless device and its MGW and then transcodes the call to AMR-WB to send to Provider B which forwards it on to the receiving wireless device. The above scenarios are merely examples. Any combination of codecs may be used.

The process of transcoding from one codec to another is resource intensive, taking up time, processing power and memory for the MGW doing the actual transcoding. Unnecessary transcoding imposes costs and delays. One way of reducing unnecessary transcoding is to stop favoring a particular codec after the negotiation. For example, the providers negotiate for a particular call to use AMR-WB. If Provider A uses AMR-WB at its end rather than EVS, as in the scenario above, then no transcoding is necessary. However, using EVS may be desirable for Provider A. EVS has better coverage than AMR-WB. A user that is on the edge of their current coverage area may risk the call using AMR-WB dropping, but the improvement provided by using EVS may be sufficient to extend the coverage area enough to prevent the call from dropping. Improving the user experience for its customers in this way may be reason enough to justify the added resources of transcoding to EVS within the provider's network.

By monitoring the signal quality of the wireless device making the call, the provider is able to dynamically make a determination of when to switch to an alternative codec, such as EVS for example, within their network. This minimizes transcoding and saves resources, while still performing the transcoding when it will improve the user experience of the user making the phone call.

When a wireless device connects to a network, it sends to the provider information about the device including its capabilities. This includes the ability of the wireless device to support multiple radio bands and use carrier aggregation, as well as which codecs it supports, for example. The device registers with the Session Initiation Protocol (SIP) server during this connection process. The information sent during registration is stored within the provider's network. When a call is initiated from the wireless device, SIP is used to setup the session between the originating wireless device and the receiving wireless device. This includes negotiating a codec.

Depending on the providers of the wireless devices, the capabilities of the wireless devices and other factors, a codec will be negotiated. Currently, for calls between different providers, this will often be AMR-WB. At this point, the originating carrier may decide to stay with AMR-WB even for the portion of the call transiting their network despite a preference for EVS as long as the wireless device on their network supports it. This saves the provider the costs associated with transcoding the call to EVS.

During the call, signal quality may be monitored. This can be accomplished by having the wireless device send signal quality metrics to the provider at periodic intervals. The signal quality metric information may be stored within the provider's network. The periodic intervals could be any period of time, for example every 10 seconds or every 30 seconds. The periods could also be dynamic and do not necessarily need to follow a specific periodic schedule. The signal quality metrics could include signal-to-noise ratio (SNR) or Mean Opinion Score (MOS) values, for example. A MOS score is a measure of the overall quality of a voice call. It ranges from 1 to 5, with 1 being the worst quality and 5 being the best quality. A MOS score below 3 is typically considered the start of the range of poor quality. The threshold can be set to any value such as an MOS score of 2 or 3, for example. Other signal quality metrics such as RSRP, RSRQ, or RSSI may be used as well. A provider may also choose to use any combination of the above-mentioned signal quality metrics, each with their own thresholds.

During the call, while using the AMR-WB codec, if the call quality deteriorates to a point that the call is at risk of dropping, the call may be changed to use an alternative codec, such as EVS for example, within the providers network to try to prevent the call from being dropped. The alternative codec may be used between the wireless device and the MGW of the provider to improve the signal quality for the provider's customer on the call. The threshold at which the change to the alternative codec is triggered is fully configurable and could be any value of SNR or MOS, for example. A provider may decide that any call quality below an MOS score of 3 is sufficient to trigger the change to the alternative codec, for example. The change may be accomplished by sending a SIP update to the wireless device for a codec change from AMR-WB to the alternative codec, such as EVS for example.

The trigger to change to the alternative codec may be controlled by more than just a single instance of signal quality falling below the threshold. For example, determining that the signal quality is below the threshold for a predetermined number of periods may trigger the change. Any number of consecutive periods may be configured to trigger the change. Two or three consecutive periods, for example. The trigger could also be defined by a certain amount of time below the threshold. For example, if the call quality stays below the threshold for 1 minute, it could trigger the change in codecs. This could be two periods if the monitoring period is every 30 seconds or six periods if it is every 10 seconds. Any amount of time or number of periods could be used.

The provider may have the option of backing out of the codec change if signal quality improves. If the signal quality metric rises to meet or exceed the threshold, either one time or for a number of intervals or an amount of time, the provider might change back to the original codec (e.g. AMR-WB, for example) for the portion of the call between the wireless device and MGW on their network. Alternatively, the provider may trigger a new codec negotiation at that point and use whatever codec is negotiated.

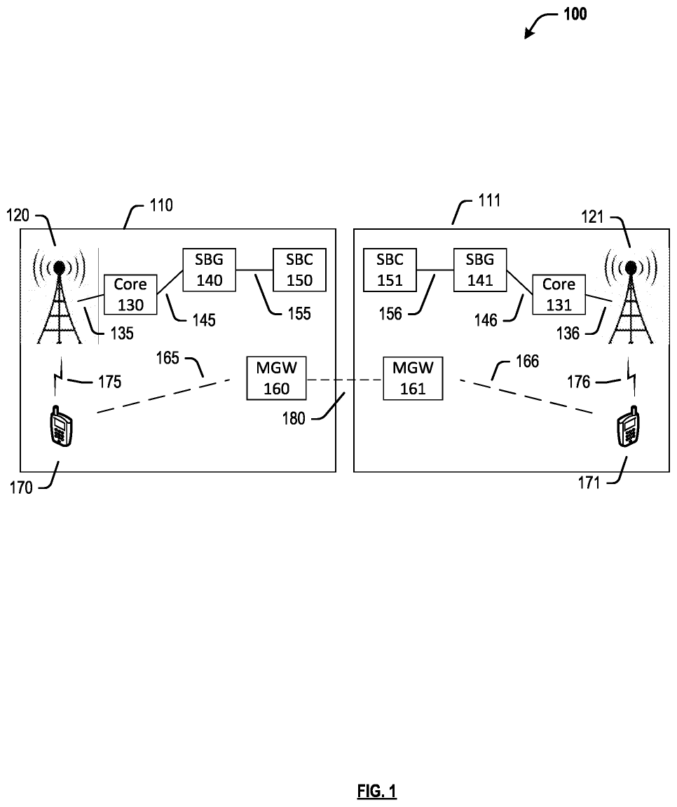

FIG. 1 depicts an exemplary system 100 for wireless communication. System 100 includes a provider network 110 for a first provider and a provider network 111 for a second provider. Within each provider network 110, 111 there are access nodes 120, 121, core network functions 130, 131, Session Border Gateways (SBGs) 140, 141, Session Border Controllers (SBCs) 150, 151, Media Gateways (MGWs) 160, 161 and wireless devices 170, 171. The wireless devices 170, 171 communicate with their respective access nodes 120, 121 over communication links 175, 176. The core network functions 130, 131 communicate with their respective access nodes via communication links 135, 136. The SBGs 140, 141 communicate with their respective core network functions 130, 131 via communication links 145, 146. The SBCs 150, 151 communicate with their respective SBGs 140, 141 via communication links 155, 156. The various communication links 135, 136, 145, 146, 155, 156, 175, and 176 may be implemented by any appropriate networking technology. For example, communication links 175 and 176 may be 3G (e.g., GSM, CDMA etc.), 4G (e.g., WiMax, LTE, etc.), or 5G (new radio (NR)) cellular technology. As another example, communication links 135, 136, 145, 146, 155, and 156 may use wired or wireless connections and may use networking protocols such as Internet protocol (IP), local-area network (LAN), optical networking, hybrid fiber coax (HFC), telephony, T1, or some other communication format-including combinations, improvements, or variations thereof.

While one of each component is shown for each provider in FIG. 1, it should be understood that any component shown may represent multiples of that component. For example, the MGW 160, 161 may actually comprise multiple media gateways configured in any load balancing or failover setups as appropriate. Similarly, multiple access nodes 120, 121 may be present in each of the providers' networks 110, 111.

Access nodes 120, 121 can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes 120, 121 may comprise two co-located cells, or antenna/transceiver combinations that are mounted on the same structure. Alternatively, access nodes 120, 121 may comprise a short range, low power, small-cell access node such as a microcell access node, a picocell access node, a femtocell access node, or a home eNodeB device.

Each of wireless devices 170, 171 may be capable of simultaneously communicating with their respective access nodes 120, 121 using combinations of antennae via 4G and 5G or any other RAT or transmission mode, including multiple carriers. For instance, MU-MIMO pairings and SU-MIMO pairings can be made by wireless devices 170, 171. It is noted that any number of access nodes, antennae, MU-MIMO pools, carriers, and wireless devices (both fixed and mobile) may be implemented.

Wireless devices 170, 171 may be any device, system, combination of devices, or other such communication platform capable of communicating on the wireless network using one or more frequency bands deployed therefrom. Wireless devices 170, 171 may be, for example, mobile phones, wireless phones, personal digital assistants (PDA), tablet computers, as well as other types of devices or systems that can exchange audio or data via the wireless network.

In operation, system 100 may be configured to execute a method including monitoring a signal quality metric of an originating wireless device 170 during a voice call with a terminating wireless device 171. The virtual links 165, 166, and 180 are representative of the traffic flow of the call while not showing all of the interim steps for the sake of clarity. The call may be using a negotiated codec or a default codec and may be AMR-WB, for example. In this example, the traffic over the virtual links 165, 180, and 166 is all encoded with AMR-WB.

If the signal quality metric drops below a threshold, the call is at risk of being dropped or at least having deteriorating voice quality. The signal quality metric may be a Mean Opinion Score (MOS) or a signal-to-noise ratio or any other meaningful metric for measuring the quality of a voice call. If the signal quality metric drops below the threshold, the call is transitioned to an alternative codec, such as EVS for example, for the originating side of the call, between the originating wireless device 170 and the MGW 160. This leads to traffic over the virtual link 165 being encoded with the alternative codec and the remainder of the call virtual links 180, 166 being unchanged.

Monitoring the signal quality metric may include periodically receiving the signal quality metric from the wireless device 170. For example, the signal quality metric may be received with a period of every 30 seconds. However, any period value could be used. The transition to the alternative codec may be triggered on a single instance of the signal quality metric going below the threshold. Alternatively, it could be triggered on a predetermined number of consecutive instances received over a predetermined number of periods of the signal quality metric being below the threshold. For example, the transition may trigger after two consecutive instances received over two consecutive periods of the MOS score being below a value of 3.

The methods executed using system 100 may include a process for backing out of the transition to the alternative codec if the signal quality metric improves. Specifically, if the signal quality metric improves to meet or exceed the threshold, a new codec negotiation for the call may be triggered or the portion of the call on virtual link 165 may transition back to the original codec. Again, this may be triggered after a single instance of the signal quality metric being at or above the threshold, or it may be after a number of consecutive instances.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by wireless devices 170, 171. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by the communication links 135, 136, 145, 146, 155, and 156 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM).

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

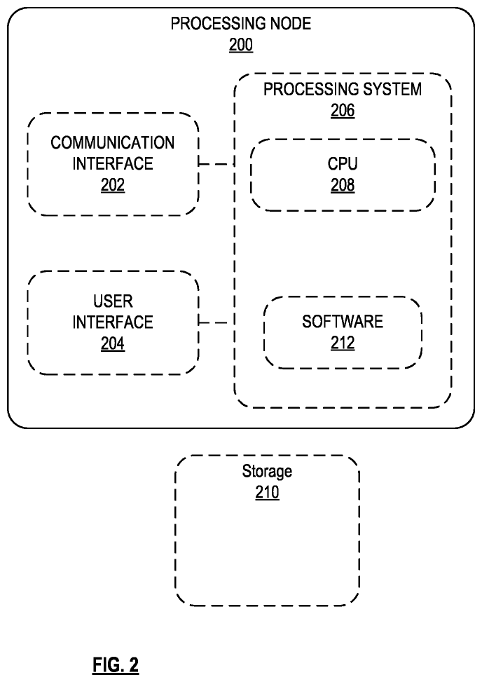

FIG. 2 depicts an exemplary processing node 200, which may be configured to perform the methods and operations disclosed herein to manage codecs for VOLTE calls. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a processor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200. Processing node 200 may be included in various elements of the wireless network including an access node, SBG, SBC or MGW, for example.

In an exemplary embodiment, software 212 can include instructions for monitoring a signal quality metric of a wireless device during a voice call. The instructions may further include determining if the signal quality metric has dropped below a threshold. If it has dropped below the threshold, the portion of the call between the wireless device and the media gateway of the provider serving the wireless device may be transitioned to an alternative codec, such as EVS for example. The signal quality metric may be a Mean Opinion Score (MOS) or a signal-to-noise ratio or any other meaningful metric for measuring the quality of a voice call.

Monitoring the signal quality metric may include periodically receiving the signal quality metric from the wireless device. The transition to the alternative codec may be triggered on a single instance of the signal quality metric going below the threshold. Alternatively, it could be triggered after a predetermined number of consecutive instances of the signal quality metric being below the threshold. For example, the transition may trigger after two consecutive instances of the MOS score being below a value of 3.

The operations may include a process for backing out of the transition to an alternative codec if the signal quality metric improves. Specifically, if the signal quality metric improves to meet or exceed the threshold, a new codec negotiation for the call may be triggered or the portion of the call between the wireless device and the MGW may transition back to the original codec. Again, this may be triggered after a single instance of the signal quality metric being at or above the threshold, or it may be after a number of consecutive instances.

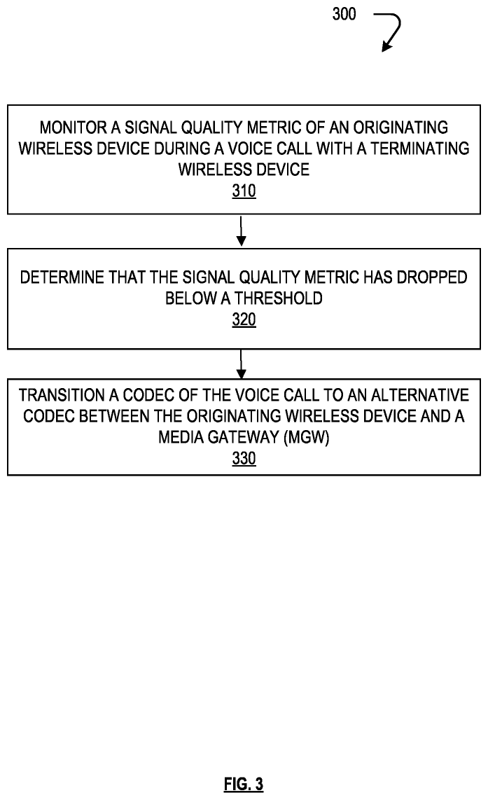

FIG. 3 illustrates an exemplary method 300 for managing codecs for a voice call in a wireless network. Method 300 can be implemented by any suitable combination of processors, such as processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins in step 310 where a signal quality metric of an originating wireless device is monitored during a voice call with a terminating wireless device. Method 300 continues in step 320 where it is determined that the signal quality metric has dropped below a threshold. Method 300 continues in step 330 where a codec of the voice call is transitioned to an alternative codec, such as EVS for example, between the originating wireless device and an MGW. The signal quality metric may be a Mean Opinion Score (MOS) or a signal-to-noise ratio or any other meaningful metric for measuring the quality of a voice call.

Monitoring the signal quality metric may include periodically receiving the signal quality metric from the originating wireless device. The transition to the alternative codec may be triggered on a single instance of the signal quality metric dropping below the threshold. Alternatively, it could be triggered after a predetermined number of consecutive instances of the signal quality metric being below the threshold. For example, the transition may trigger after two consecutive instances of the MOS score being below a value of 3.

The method may include optional steps for backing out of the transition to the alternative codec if the signal quality metric improves. Specifically, if the signal quality metric rises to meet or exceed the threshold, a new codec negotiation for the call may be triggered or the portion of the call between the wireless device and the MGW may transition back to the original codec. Again, this may be triggered after a single instance of the signal quality metric being at or above the threshold, or it may be after a number of consecutive instances.

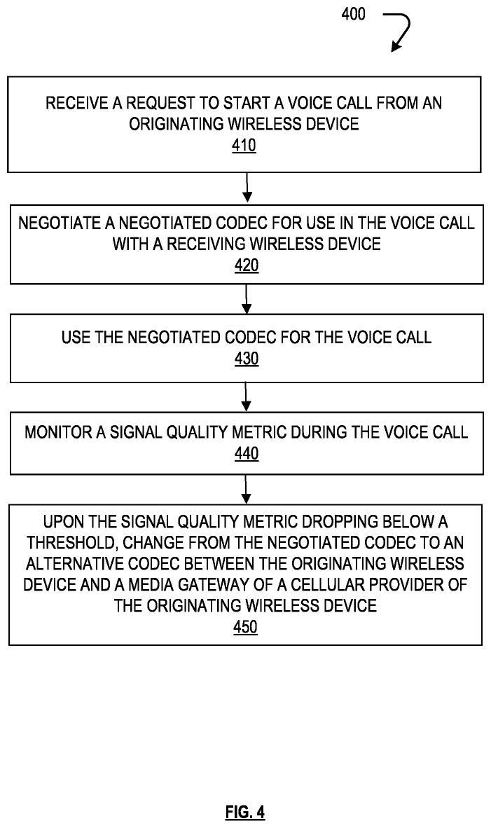

FIG. 4 illustrates an exemplary method 400 for managing codecs for a voice call in a wireless network. Method 400 can be implemented by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a request to start a voice call is received from an originating wireless device. Method 400 continues in step 420 where a negotiated codec is negotiated for use in the voice call with a receiving wireless device. Method 400 continues in step 430 where the negotiated codec is used for the voice call. Method 400 continues in step 440 where a signal quality metric is monitored during the call. Method 400 continues in step 450 where upon the signal quality metric dropping below a threshold, the portion of the voice call between the originating wireless device and the media gateway of the provider of the originating wireless device is transitioned from the negotiated codec to an alternative codec, such as EVS for example. The signal quality metric may be a Mean Opinion Score (MOS) or a signal-to-noise ratio or any other meaningful metric for measuring the quality of a voice call.

Monitoring the signal quality metric may include periodically receiving the signal quality metric from the originating wireless device. The transition to the alternative codec may be triggered on a single instance of the signal quality metric dropping below the threshold. Alternatively, it could be triggered on a predetermined number of consecutive instances of the signal quality metric being below the threshold. For example, the transition may trigger after two consecutive instances of the MOS score being below a value of 3.

The method may include optional steps for backing out of the transition to the alternative codec if the signal quality metric improves. Specifically, if the signal quality metric rises to meet or exceed the threshold, a new codec negotiation for the call may be triggered or the portion of the call between the wireless device and the MGW may transition back to the original codec. Again, this may be triggered on a single instance of the signal quality metric being at or above the threshold, or it may be after a number of consecutive instances.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
monitoring a signal quality metric of an originating wireless device during a voice call with a terminating wireless device;
determining that the signal quality metric has dropped below a threshold; and
transitioning a codec of the voice call from an original codec to an alternative codec between the originating wireless device and a Media Gateway (MGW).

2. The method of claim 1, wherein the signal quality metric comprises Mean Opinion Score (MOS), or a signal-to-noise ratio.

3. The method of claim 1, wherein the alternative codec is Enhanced Voice Services (EVS) codec.

4. The method of claim 1, the method further comprising:
determining that the signal quality metric has risen to meet or exceed the threshold; and
negotiating a negotiated codec for use on the voice call with the terminating wireless device.

5. The method of claim 1, the method further comprising:
determining that the signal quality metric has risen to meet or exceed the threshold; and
configuring the voice call to use the original codec between the originating wireless device and the MGW, wherein the original codec was assigned to the voice call when the voice call began.

6. The method of claim 1, wherein the monitoring the signal quality metric of a wireless device during a voice call comprises periodically receiving the signal quality metric from the wireless device, and wherein the determining that the signal quality metric has dropped below the threshold comprises determining that the signal quality metric has dropped below the threshold for a number of consecutive periods.

7. The method of claim 6, wherein the number of consecutive periods is at least 2.

8. A system, the system comprising:
a session border gateway including at least one electronic processor configured to perform operations, the operations including:
monitoring a signal quality metric of a wireless device during a voice call;
determining that the signal quality metric has dropped below a threshold; and
transitioning a codec of the voice call from an original codec to an alternative codec between the wireless device and a media gateway (MGW).

9. The system of claim 8, wherein the signal quality metric comprises Mean Opinion Score (MOS), or signal-to-noise ratio.

10. The system of claim 8, wherein the alternative codec is Enhanced Voice Services (EVS) codec.

11. The system of claim 8, the operations further including:
determining that the signal quality metric has risen to meet or exceed the threshold; and
negotiating a negotiated codec for use on the voice call with a terminating wireless device.

12. The system of claim 8, the operations further including:
determining that the signal quality metric has risen to meet or exceed the threshold; and
configuring the voice call to use the original codec between the wireless device and the MGW, wherein the original codec was assigned when the voice call began.

13. The system of claim 8, wherein the monitoring the signal quality metric of the wireless device during a voice call comprises periodically receiving the signal quality metric from the wireless device, and wherein the determining that the signal quality metric has dropped below the threshold comprises determining that the signal quality metric has dropped below the threshold for a number of consecutive periods.

14. A method, the method comprising:
receiving a request to start a voice call from an originating wireless device;
negotiating a negotiated codec for use in the voice call with a receiving wireless device;
using the negotiated codec for the voice call;
monitoring a signal quality metric during the voice call; and
upon the signal quality metric dropping below a threshold, transitioning from the negotiated codec to an alternative codec between the originating wireless device and a media gateway of a cellular provider of the originating wireless device.

15. The method of claim 14, wherein the signal quality metric comprises Mean Opinion Score (MOS), or signal-to-noise-ratio.

16. The method of claim 14, wherein the alternative codec is Enhanced Voice Services (EVS) codec.

17. The method of claim 14, the method further comprising:
determining that the signal quality metric has risen to meet or exceed the threshold; and
re-negotiating another codec for use on the voice call with the receiving wireless device.

18. The method of claim 14, the method further comprising:
determining that the signal quality metric has risen to meet or exceed the threshold; and
configuring the voice call to use the negotiated codec.

19. The method of claim 14, wherein the monitoring the signal quality metric of the originating wireless device during a voice call comprises periodically receiving the signal quality metric from the originating wireless device, and wherein the determining that the signal quality metric has dropped below the threshold comprises determining that the signal quality metric has dropped below the threshold for a number of consecutive periods.

20. The method of claim 19, wherein the number of consecutive periods is at least 2.
